(19) United States
(12) Patent Application Publication
(10) Pub. No.: US 2013/0175226 A1
(43) Pub. Date: Jul. 11, 2013

(54) ACOUSTIC SEPARATORS

(71) Applicants: Constantin Coussios, Oxford (GB); Yiannis Ventikos, Oxford (GB); Giuliana Trippa, Epsom (GB); David Taggart, Oxford (GB)

(72) Inventors: Constantin Coussios, Oxford (GB); Yiannis Ventikos, Oxford (GB); Giuliana Trippa, Epsom (GB); David Taggart, Oxford (GB)

(73) Assignee: ISIS INNOVATION LIMITED, Oxford, Oxfordshire (GB)

(21) Appl. No.: 13/805,551

(22) PCT Filed: Jun. 24, 2011
(86) PCT No.: PCT/GB2011/051189

§ 371 Date: Feb. 27, 2013

(30) Foreign Application Priority Data
Jun. 25, 2010 (GB) GB1010724.1
Jun. 24, 2011 (GB) PCT/GB2011/051189

(51) Int. Cl. B01D 21/28

(52) U.S. Cl. CPC B01D 21/28
USPC 210/748.05; 29/428; 422/127

(57) ABSTRACT

An acoustic separator comprises: two parallel chamber walls defining a separation chamber therebetween, each chamber wall defining one side of the chamber; inlet means through which fluid can flow into the chamber; and outlet means through which fluid can flow out of the chamber. One of the chamber walls includes a transducer arranged to transmit pressure waves across the chamber towards the other of the chamber walls which in turn is arranged to reflect the pressure waves to set up a standing wave in the chamber. The outlet means defines an opening in one of the sides of the chamber.

### FIELD OF THE INVENTION

The present invention relates to acoustic separators. It has application, for example, in the separation of micron-sized particles in a biomedical context, such as for the separation of lipid microemboli from pericardial suction blood (where it would replace cell-saver devices which are effectively centrifuges that can only be used in batch mode, rather than continuous flow). However, the invention can be scaled and adapted for a broad array of filtration and separation applications, such as in areas of chemical engineering such as handling or separation of emulsions and particle suspensions and in food processing.

### BACKGROUND OF THE INVENTION

Particle separation is today most commonly achieved by conventional membrane filtration. This presents the disadvantage that particles can only be separated on the basis of size and offers no solution to separating and manipulating different particles of similar sizes. Centrifugation-based techniques (such as cell-saver devices in a biomedical context) offer a density-based alternative, but those devices usually require a minimum initial volume to operate and can only operate in batch mode, rather than in continuous flow.

Ultrasonic standing waves (USW) have been used for a number of years to manipulate particles and separate them from liquids. This method has particular application where particles cannot be filtered solely on the basis of size. When particles suspended in a liquid are placed in an ultrasonic standing wave field, they experience an acoustic radiation force that is a function of the difference in density and compressibility between the particles and the suspending medium as well as of the particle size. This force, if of adequate magnitude, causes particles to collect at the pressure maxima (pressure antinodes) or at the pressure minima (pressure nodes) in the standing wave field depending on the values of their density and compressibility. The acoustic radiation force can be calculated from the following expression:

$${F}_{ar} = - ( \frac{{πP}_{0}^{2} {V}_{p} {κ}_{f}}{2 λ} ) Φ ( κ , ρ ) sin ( 2 ky ) . \qquad ( 1 )$$

In (1), P₀ (Pa) is the acoustic pressure amplitude, κ_{f} (Pa⁻¹) is the compressibility of the fluid, λ (m) is the wavelength of ultrasound in the suspending phase, Vₚ (m³) the particle volume, y (m) the distance from a pressure node and k=2π/λ.

Φ (dimensionless) is the acoustic contrast factor of the suspended particles:

$$Φ ( κ , ρ ) = \frac{5 {ρ}_{p} - 2 {ρ}_{f}}{2 {ρ}_{p} + {ρ}_{f}} - \frac{{κ}_{p}}{{κ}_{f}} \qquad ( 2 )$$

where ρₚ (kg/m³) and ρ_{f} (kg/m³) are the density of the particles and the fluid respectively, and κₚ (Pa⁻¹) and κ_{f} (Pa⁻¹) are the compressibility of the particles and the fluid respectively. If, for a given particle, Φ<0 then the acoustic radiation force is positive and the particles will move away from the pressure node, towards an antinode. If Φ>0 then the acoustic radiation force is negative and particles will tend to move towards a nodal position. The manipulation and separation of particles through the use of standing waves have been reported for a variety of acoustic resonator designs with polystyrene spheres or latex particles or different types of cells. In recent years there has been increasing interest in the use of standing waves, particularly in the context of development of lab on a chip devices and biosensors.

Several studies in recent years have demonstrated that cardiotomy suction blood collects gas and particulate matter as it is retrieved from the pericardium, open pleural cavities and mediastinum. Lipid particles, which are amongst the impurities the blood becomes contaminated with, can be particularly harmful to the patient. If the PSB is re-transfused without prior processing, the lipid particles enter the blood circulation and can build-up in the brain and other organs. Lipid particles have been identified in the brain microvasculature of patients that had undergone cardiac surgery and had caused small capillary and arteriolar dilatations (SCAD). The lipid particles that build up in the brain have been related to the occurrence of post-operative cognitive disorders also referred to as diffuse brain damage (DBD). As re-transfusion of the patient's own blood is the preferred choice during surgery, techniques for the removal of lipid particles from blood have increasingly been looked at in the last few years. Conventional membrane-based filtration of the lipids has shown some positive results, with the limitation that the filters used must have a pore size that is larger than the size of the blood components. Lipid particle size has been reported to vary between 10 μm and 70 μm, but as red blood cells (RBCs) have an equivalent spherical mean diameter of 5.5 μm, it is difficult to identify lipid particles of sizes comparable to that of RBCs by filtration and lipid particles of 10 μm in size or lower could still build-up in the microvasculature of the brain. A method that allows the removal of lipid particles over a range of sizes would be more effective than filtration. Centrifugation can be used to separate lipids, but it has to be carried out in batch and some of the blood can be lost during this off-line procedure. A continuous method that allows processing of the cardiotomy suction blood as it is collected and before re-transfusion to the patient would be preferable in the context of ease of operation and containment of the blood.

Ultrasonic processing through the use of standing waves has been tested by Laurell and co-workers who have reported the separation of different types of particles, including lipid particles and erythrocytes suspended in blood plasma, by using USW in silicon-etched microchannels [A. Nilsson, F. Petersson, H. Jönsson, and T. Laurell, “Acoustic control of suspended particles in micro fluidic chips,” Lab Chip, vol. 4, pp. 131-135, 2004; and F. Petersson, A. Nilsson, C. Holm, H. Jönsson, and T. Laurell, “Separation of lipids from blood utilizing ultrasonic standing waves in microfluidic channels,” Analyst, vol. 129, pp. 938-943, 2004]. The channels were either 750 μm or 350 μm wide. Lipid particles and RBCs suspended in plasma have acoustic contrast factors of opposite signs (negative for the lipids and positive for the RBCs); this allows the separation of the two in USW fields as the RBCs will tend to migrate to the nodes, whereas the lipids will tend to move towards the antinodes. Jönsson et al. [H. Jönsson, C. Holm, A. Nilsson, F. Petersson, P. Johnsson, and T. Laurell, “Particle separation using ultrasound can radically reduce embolic load to brain after cardiac surgery,” Ann. Thorac. Surg., vol 78, pp. 1572-1578, 2004] showed that they could use an array of eight microfabricated 375 μm wide channels to remove lipid particles from blood using USWs whilst achieving a higher throughput of processed blood than with a single channel. The authors tested erythrocyte concentrations between 5% and 30% and obtained a mean lipid separation of 81.9%±7.6% using initial concentrations of lipids of 0.5%, 1%, 2%. The separation efficiency for lipids varied between 66% and 94%. Jönsson et al. [H. Jönsson, A. Nilsson, F. Petersson, M. Allers, and T. Laurell, “Particle separation using ultrasound can be used with human shed mediastinal blood,” Perfusion, vol. 20, pp. 39-43, 2005.] reported testing the multi-channel device with human shed mediastinal blood and obtaining a mean erythrocyte recovery ratio of 85.2%. In the tests with human blood the separation efficiency of lipids was not quantified. The device with the eight channels can reportedly process approximately 60 ml/hour, which corresponds to 1.67·10⁻² cm³/s, and the processing demand for blood during cardiac surgery will reportedly be at least 20 times higher. This may be achieved by increasing the number of channels operating in parallel. The scale-up strategy through replication of the single channel unit is often reported as the most obvious one for microchannels; however, as the number of single microstructured channels increases, problems of flow distribution and lack of homogeneity of processing conditions between the various units are likely to emerge.

### SUMMARY OF THE INVENTION

The present invention provides an acoustic separator comprising two parallel chamber walls defining a separation chamber therebetween. Each chamber wall may define one side of the chamber. The separator may comprise inlet means through which fluid can flow into the chamber, and may comprise outlet means through which fluid can flow out of the chamber. One of the chamber walls may include a transducer which may be arranged to transmit pressure waves across the chamber, for example towards the other of the chamber walls, which in turn may be arranged to reflect the pressure waves to set up a standing wave in the chamber. The outlet means may define an opening in one of the sides of the chamber. The outlet means may include an outlet duct, which may have side walls extending perpendicular to the chamber side walls.

The chamber may be at least part annular. In that case, fluid flow through the chamber may be substantially radial. In some cases the chamber is annular. The inlet means may be radially outward of the outlet means. This provides converging flow of the fluid which tends to be stable and laminar. Alternatively the inlet means may be radially inward of the outlet means. The inlet means may be at the radially outer edge of the chamber. The outlet means may be at the radially inner edge of the chamber.

The outlet means may be one of a plurality of outlet means which are located at different distances from the inlet means. This can allow separation of more than one type of particle from a fluid.

The standing wave within the chamber may be less than one wavelength in length. The standing wave may have an anti-node at said one of the chamber walls and a node which is further from said one of the chamber walls than from the other of the chamber walls.

Preferably the standing wave within the chamber is not more than a quarter wavelength, and it may be about a quarter wavelength.

Said other of the chamber walls, i.e. the one which is arranged to act as a reflector, may comprise a membrane.

Indeed the present invention further provides an acoustic separator comprising two parallel chamber walls defining a separation chamber therebetween, inlet means through which fluid can flow into the chamber, and outlet means through which fluid can flow out of the chamber, wherein one of the chamber walls includes a transducer arranged to transmit pressure waves across the chamber towards the other of the chamber walls, which comprises a membrane and is arranged to reflect the pressure waves to set up a standing wave in the chamber.

The membrane is preferably supported in tension, and may be supported between the chamber and a gas. For example said other of the chamber walls may further comprise support means arranged to support the membrane and to contain a volume of gas on the opposite side of the membrane to the chamber.

The separator may further comprise a pressure sensing means arranged to measure variations in pressure produced by the transducer and control means arranged to control the frequency of the pressure waves in response to an output from the pressure sensing means. The pressure sensing means may be arranged to measure pressure at said other of the chamber walls. The control means may be arranged to vary the frequency so as to bring the variations in pressure towards a target variation, for example towards a target magnitude of the pressure variation, which may be zero.

The separator may be used, for example, for the removal of lipid particles from pericardial suction blood (PSB) collected during cardiac surgery.

Embodiments of the present invention can operate with radial inward flow. When used with blood, the blood may flow between two plates or discs from a radial peripheral inlet towards an axial central outlet. The aim of some embodiments of the invention is a separator that can handle a throughput that is relevant to the needs of cardiac surgery and that can perform effectively in removing lipid particles from blood. The design of some embodiments was carried out by developing a CFD (Computational Fluid Dynamics)-based model, taking into account the flow configuration and the forces experienced by the particles in the separator. Scaling up the device to handle larger flow rates can be achieved by increasing the diameter of the radial flow separator. Whilst the radial flow configuration requires thorough engineering of the final device for any specific application, the chosen geometry and flow configuration common to the preferred embodiments avoid the aforementioned issues arising from flow splitting in microstructured devices. In terms of acoustic configuration, the separator design may utilize an approximately quarter wavelength standing wave. CFD has been used before to characterize the flow in an ultrasonic separator and the information obtained was incorporated into a separate numerical model for the particle trajectories [R. J. Townsend, M. Hill, N. R. Harris, and N. M. White, “Modelling of particle paths passing through an ultrasonic standing wave,” Ultrasonics, vol. 42, pp. 319-324, 2004]. However, in the present invention the flow field and the forces on the particles were both included within one model for an acoustic separator to enable optimization of its design.

The present invention further provides a method of separating particles from a fluid comprising providing a separator according to the invention, operating the transducer to generate the standing wave, and passing the fluid through the separation chamber. The fluid may be a liquid or a gas. The method may separate one type of particle out of the fluid, of a plurality of different types of particles. The particles may be solid or they may be liquid. The fluid flow rate may be controlled, for example to maintain substantially laminar flow in the separator chamber.

The method may further comprise modelling operation of the separator, for example by modelling fluid flow in the separator, to determine a target value for a parameter of the separator, or its operation, and controlling the parameter to maintain it at the target value.

The present invention further provides a method of constructing a separator according to the invention for separating particles from a fluid, the method comprising modelling fluid flow in the separator to determine a target value for at least one parameter of the separator, and constructing the separator so that the parameter has the target value.

In either of these methods, the parameter may be flow rate, such as volumetric flow rate, of the fluid through the separator, or fluid temperature, or fluid pressure, which will affect the flow of fluids in some cases. The parameter may be a dimension of the separation chamber, or of the inlet, or of the outlet, or any combination thereof. The parameter may be controlled by adjustment of the separator. In other cases the parameter may be controlled by constructing the separator to have the target dimension or dimensions. In other cases the parameter may be the frequency of the pressure waves. Any two or more of these parameters can be controllable

The modelling may include modelling of fluid flow through the separator, for example using the Navier-Stokes equation. The modelling may include modelling any one or more of: the acoustic force on the particles, the buoyancy of the particles, gravitational forces on the particles, and drag force exerted on the particles by the fluid.

Preferred embodiments of the present invention will now be described by way of example only with reference to the accompanying drawings.

### BRIEF DESCRIPTION OF THE DRAWINGS

FIG. 1 is a schematic section through an acoustic separator according to an embodiment of the invention;

FIGS. 2a and 2b are diagrams showing standing wave configurations within the separator of FIG. 1, FIG. 2b representing the preferred configuration;

FIG. 3a is a diagram showing dimensional parameters used in modelling the operation of the separator of FIG. 1;

FIG. 3b is a diagram showing the injector positions used in the modelling;

FIGS. 3c and 3d show the radial fluid velocities in two different models of the separator;

FIG. 4 is a graph showing the effectiveness of various separators of different dimensions, according to a modelling process;

FIG. 5 is a section through a separator according to a further embodiment of the invention;

FIG. 6 is a cross section through a separator according to a further embodiment of the invention;

FIG. 7 is a cross section through a separator according to a further embodiment of the invention; and

FIG. 8 is partial section through a separator according to a further embodiment of the invention.

### DESCRIPTION OF THE PREFERRED EMBODIMENTS

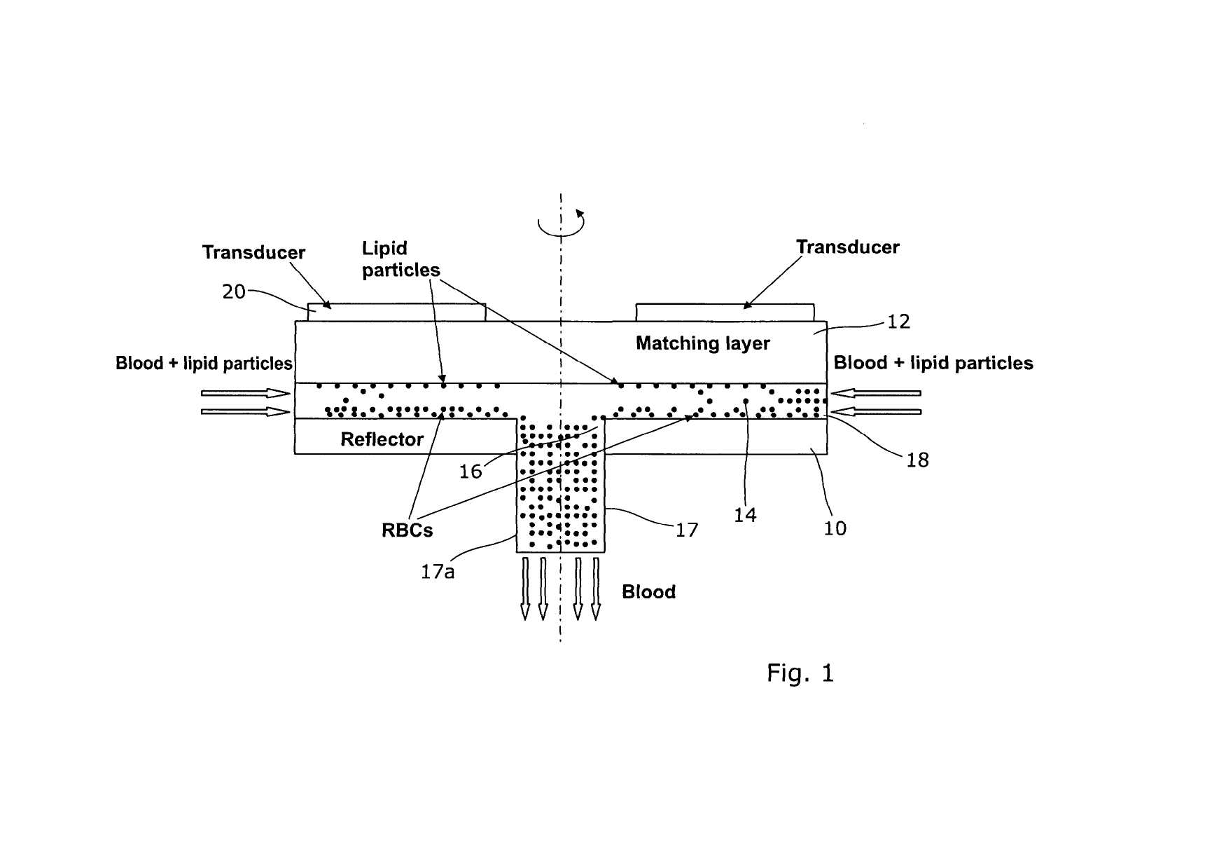

Referring to FIG. 1, an acoustic separator according to an embodiment of the invention comprises two parallel circular plates 10, 12 which form two side walls, defining a separation chamber 14 between them. The lower plate 10 has an aperture 16 in its centre which forms an outlet. An outlet duct 17 extends from the outlet 16 in the downward direction, perpendicular to the plates 10, 12. The side walls 17a of the outlet duct are joined to the lower plate 10 around the edge of the outlet 16 and extend downwards, perpendicular to the plates 10, 12. The radially outer edge of the separation chamber 14 forms an inlet 18 so that, in operation, fluid flows radially inwards from the edge of the separation chamber 14, and then turns through a right angle and flows axially outwards through the outlet 16. An annular piezoelectric transducer 20 is located on top of the upper plate 12 and is arranged to vibrate in the vertical direction transmitting acoustic waves vertically downwards through the separation chamber. The upper plate 12 acts as a matching layer between the transducer 20 and the separation chamber 14. The acoustic waves are reflected off the lower plate 10 so that, under the correct conditions, a standing wave is set up in the separation chamber 14. The inlet 18 is connected to a fluid supply which is arranged to control the flow rate of fluid through the separator. The fluid flow rate is controlled so as to maintain laminar flow through substantially the whole of the separation chamber. The effect of fluid flow rate on separation efficiency can be modelled as will be described in more detail below, and a target or optimum flow rate selected for a specific separator design and fluid composition.

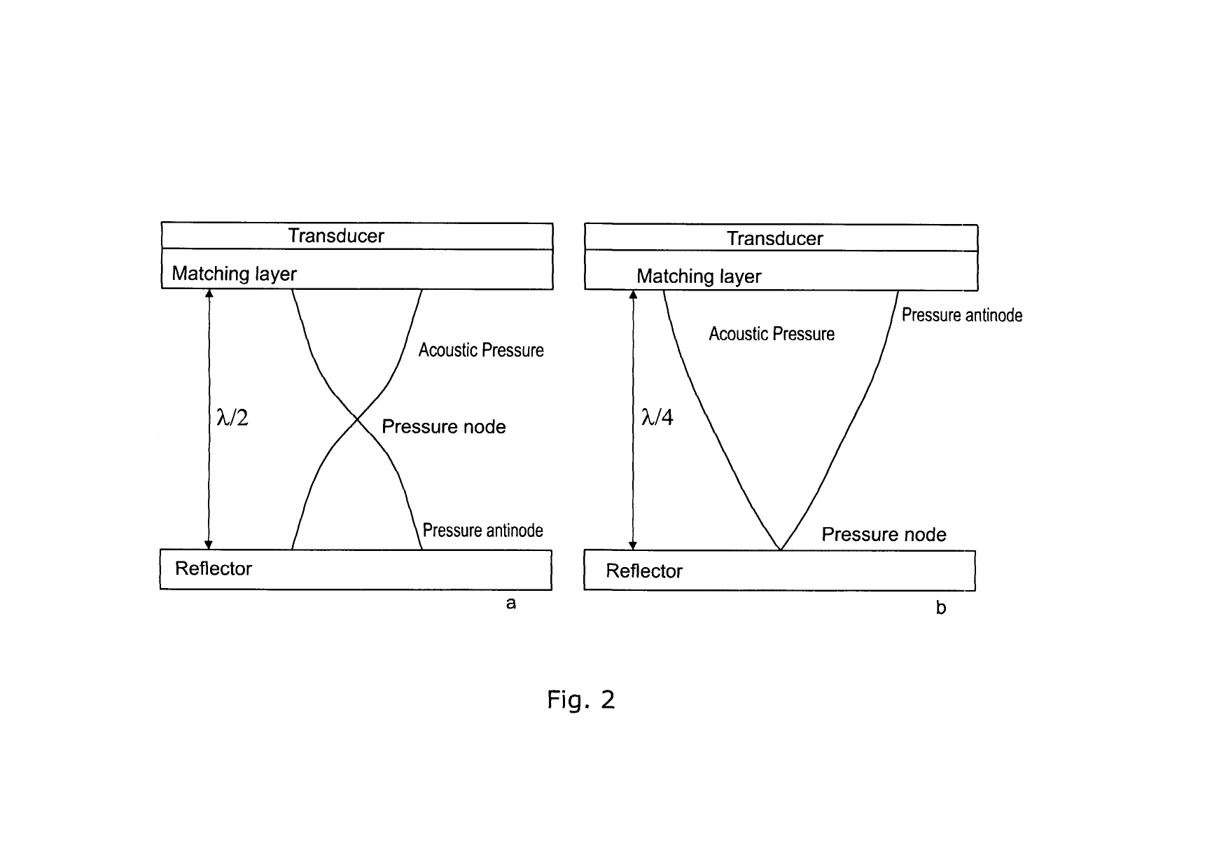

Referring to FIG. 2, the standing wave that can be set up in the separation chamber 14 depends on the axial height of the chamber 14 and the wavelength of the acoustic waves. Referring to FIG. 2a, if the height of the chamber is half the acoustic wavelength then a half wavelength standing wave can be sent up with an anti-node, where the variation in pressure through one period of the acoustic wave is a maximum, at the top and bottom of the chamber 14. Referring to FIG. 2b, if the height of the chamber is a quarter of the acoustic wavelength then a quarter wavelength standing wave can be set up, with a pressure node, where the variation in pressure is zero, at the lower plate 10 at the bottom of the chamber 14. Since the acoustic forces on particles in the separation chamber 14 will be either towards the nodes or towards the anti-nodes, it will be appreciated that the quarter wavelength configuration has the advantage that all particles of one type will be urged in the same direction, towards either the top or the bottom of the chamber 14, wherever they are within the chamber, and all particles of a different type with an opposite acoustic contrast factor will be urged in the opposite direction, providing maximum separation. In contrast, in the half wavelength configuration one group of particles will be urged towards the node at the vertical centre of the chamber 14, and another group will be split between the top and the bottom of the chamber at the anti-nodes. In this embodiment the quarter wavelength configuration of FIG. 2b is used.

When the separator of FIG. 1 is being used to separate lipids from blood, the blood is introduced into the separation chamber 14 at the inlet 18, for example via a number of nozzles spaced around the circumference of the separator, and flows radially inwards, generally parallel to the side walls, through the separation chamber 14. From the centre of the chamber 14, where the blood flow is turned through 90 degrees, it flows axially downwards through the outlet 16. The blood contains red blood cells (RBCs) and lipid particles suspended in plasma. As described above, due to their different properties, the lipid particles experience an acoustic force towards the acoustic antinodes, which in this case is towards the top of the separation chamber 14, and the RBCs experience an acoustic force towards the acoustic nodes, which in this case is in the downward direction towards the bottom of the separation chamber 14. Therefore, provided a relatively smooth laminar flow can be maintained through the separator, the lipid particles will tend to accumulate at the top of the chamber 14 whereas the RBCs will tend to move towards the bottom of the chamber. It will be appreciated that the fluid flow at the top of the chamber 14 close to the upper plate 12 will be slow, and that there will be a region of relatively static fluid at the top of the chamber 14 over the central outlet 16, and on the opposite side of the chamber from the outlet (upper rather than lower). Therefore the lipid particles will tend to collect in that region, whereas the RBCs, because they are collecting on the same (lower) side of the chamber 14 as the outlet 16, will tend to flow out through the outlet 16. If the separator is to be operated continuously, various methods can be used to collect or remove the lipid particles, as will be described in more detail below. If it is only used for short periods this may not be necessary.

As well as acoustic forces acting on the particles, gravity also assists with the separation process. Lipid particles are less dense than plasma, and RBCs are more dense than the plasma. Therefore buoyancy will tend to cause the lipid particles to rise to, and remain at, the top of the chamber 14, and gravity will tend to cause the RBCs to sink to the bottom of the chamber 14. The gravitational forces are generally significantly less than the acoustic forces. Therefore, the separator of FIG. 1 could be used in any orientation, but there is an advantage in arranging it in the orientation described with the transducer 20 at the top, so that gravity assists the separation.

It will be appreciated that the effectiveness of the separation will depend on a number of factors including the residence time, i.e. the time for which the blood is within the separation chamber 14, and the degree to which the flow can be kept laminar, which in turn will depend on the fluid velocity. It is an advantage of the arrangement of FIG. 1 that the volumetric flow rate of the separator can be increased, by increasing the inner radius of the device (i.e. the radius of the outlet 16), without altering either the height of the separation chamber 14 or the fluid flow velocity, which is greatest around the edge of the outlet 16. The residence time can be increased, independently of flow rate, by varying the outer radius of the chamber 14.

The flow in the separator can be described, considering an incompressible fluid of constant viscosity, by use of the Navier-Stokes equation

$${ρ}_{f} \frac{D v}{D t} = - ∇ p + {μ}_{f} {∇}^{2} v + {ρ}_{f} g \qquad ( 3 )$$

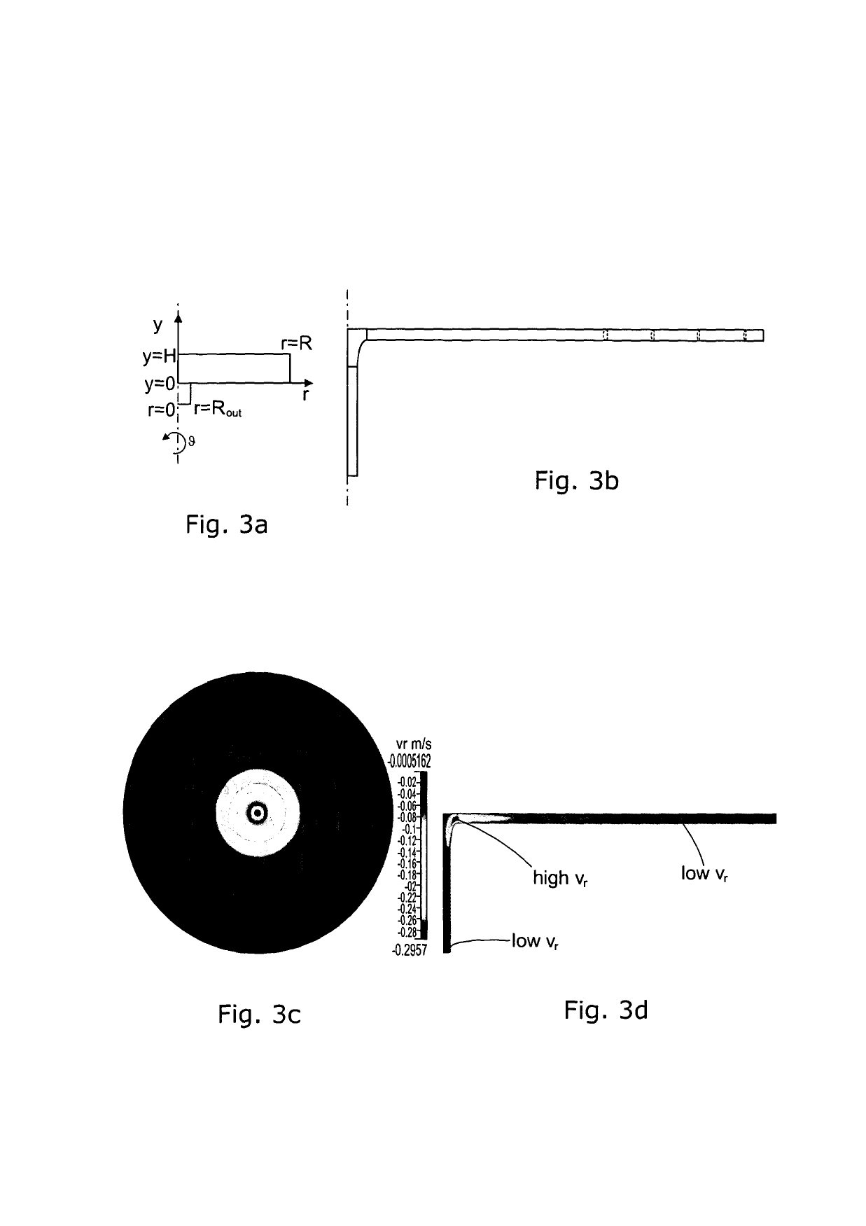

together with continuity. In (3), p is the (fluid dynamic) pressure, v is the velocity vector, g is the gravity vector and μ_{f} is the fluid dynamic viscosity. A constant value of viscosity was taken into account for blood as the calculation of average shear rates for the present case showed this assumption to be acceptable when looking at changes in blood viscosity with shear rate. The radial flow between two discs can be represented in a cylindrical coordinate system as shown in FIG. 3a. Assuming that the flow has no azimuthal component, only the r and y components of the Navier-Stokes equation need to be considered; for example, the steady state case for the r component would read,

$${ρ}_{f} {v}_{r} \frac{\partial {v}_{r}}{\partial r} = - \frac{d p}{d r} + {μ}_{f} ( \frac{{\partial }^{2} {v}_{r}}{\partial {r}^{2}} + \frac{1}{r} \frac{\partial {v}_{r}}{\partial r} - \frac{{v}_{r}}{{r}^{2}} + \frac{{\partial }^{2} {v}_{r}}{\partial {y}^{2}} ) \qquad ( 4 )$$

where vᵣ (m/s) is the radial component of velocity.

The continuity equation has in this case the following expression

$$\frac{\partial {v}_{r}}{\partial r} + \frac{{v}_{r}}{r} = 0 \qquad ( 5 )$$

which implies that (4) becomes

$${ρ}_{f} {v}_{r} \frac{\partial {v}_{r}}{\partial r} = - \frac{d p}{d r} + {μ}_{f} ( \frac{{\partial }^{2} {v}_{r}}{\partial {y}^{2}} ) \qquad ( 6 )$$

Equation (6) cannot be integrated analytically in the general case. Different approximations to the inertial term, on the left hand side of (6), have been proposed to allow for an analytical solution of the velocity profile. Substituting the average radial velocity <vᵣ> for vᵣ in (6), the average velocity <vᵣ> is given by:

$$〈 {v}_{r} 〉 = \frac{Q}{2 π rH} \qquad ( 7 )$$

where Q (m³/s) is the fluid volumetric flow rate, H (m) is the gap between the discs and the equation is valid at the generic position r. At relatively large distances from the centre of the discs and at relatively low Reynolds numbers, the flow can be approximated with the viscous case solution; the inertial term becomes more relevant at relatively low distances from the centre of the discs and at relatively high fluid velocities. These considerations are valid both for radial outward and inward flow for as long as the flow is laminar; however the outward flow is a decelerating one, whereas in the inward case the flow cross section decreases as the fluid moves towards the centre, therefore causing it to accelerate. The decreasing fluid velocities can cause loss of stability and symmetry in the outward flow, especially at relatively high flow rate; in the inward flow the acceleration towards the centre should provide a stabilizing effect. For this study, the presence of a vertical (along the transducer axis) velocity component (dominant near the outflow), together with the need to assure efficiency and avoid remixing, edge effects notwithstanding, necessitated the use of computational simulation techniques for the simultaneous evaluation of flow and particle dispersal/separation.

The first stage in the process of solving the governing equations using CFD techniques is the division of the flow domain into a number of cells; the equations are then cast in a discretized form for each cell. In this study the software package CFD-ACE+ (ESI Group, Paris, France) was used. This platform is based on the finite volume approach discretization. The solver determines a solution for the velocities and the pressure; the velocities are given by the discretized components of the Navier-Stokes equation and CFD-ACE+ uses the continuity equation to derive a pressure correction through use of the SIMPLEC (Semi-Implicit Method for Pressure-Linked Equations Consistent) algorithm. Upon convergence of the solution both momentum and mass balances are satisfied in each cell and in the entire domain. Second-order central differencing is used for the spatial discretization and an algebraic multigrid technique is used for convergence acceleration.

A series of tests were conducted to ensure the independence of the results obtained from modelling choices and numerical parameters. The set-up of these tests is described here while their outcome is discussed below. In the present embodiment the flow domain considered in most cases represents the USW separator in an axisymmetric configuration. For this case the solver assumes complete axial symmetry for the flow (independence from θ) and obtaining solutions this way is considerably faster than carrying out 3D simulations. Two full 3D simulations were also carried out to ensure that the axisymmetric hypothesis is indeed valid. These tests were carried out with a separator diameter of 12 cm and flow rates of 8.34 cm³/s and 4.17 cm³/s. Unstructured grids, generated with an advancing front method, were used for the axisymmetric simulations whereas hybrid structured-unstructured grids were used for the 3D simulations. The axisymmetric flow simulations in this work were carried out both in transient and in steady state mode. Further to these tests, a grid independence study was carried out for the axisymmetric configuration and for the flow rate of 8.34 cm³/s, with a separator diameter of 12 cm. This consisted in running the steady state simulation with a grid with a different cell number density (4 times the cell number as usual in this case) and comparing the flow solutions obtained.

Model for the Lipid Particles in the Ultrasonic Separator

The model describing particle behaviour considered blood as a homogeneous medium and lipid particles suspended in it. This allowed the model to investigate the forces acting on lipid particles primarily. For this reason, properties of blood with 40% hematocrit were considered when modelling the flow in the separator.

The concentration of lipid particles in blood was taken as 0.5% in volume. The volume based size distribution included 10% of particles of 5 μm in diameter, 65% of particles of 12.5 μm in diameter, 15% of particles of 17.5 μm in diameter and 10% of particles of 40 μm in diameter. The composition of the lipid particles was taken as that of a mixture of fatty acids (primarily palmitic, linoleic and oleic acid) not dissimilar to the composition of human fat tissue. The forces experienced by the lipid particles in the separator are gravity and buoyancy, the drag force and the acoustic radiation force given by (1). A flexible user subroutine, allowing for the application of arbitrary acoustic force fields was developed and utilized. This allows the consideration of an additional source term in the force balance for the particles. Moreover, added mass effects were taken into account. The main limitation of the model developed for predicting the behaviour of the ultrasonic separator is related to the use of (1) for the acoustic radiation force. In this model, (1) has been considered valid for each radial position in the separator, with the same value of acoustic pressure amplitude. The ultrasonic field is unlikely to be perfectly even on a relatively wide area at varying radial distances from the centre. This could cause (1) to give an overestimate of the acoustic radiation force for some areas of the separator. Although the nature of the routine developed allows for the incorporation of arbitrary acoustic force fields, a detailed characterization of the field is not currently available and the idealised acoustic pressure distribution was thus used. A second and most likely less significant limitation of the model is related to not taking into account the secondary radiation force acting on the lipid particles. This force is generated on a particle by the sound field scattered from an adjacent particle. It has been shown that the maximum secondary radiation force on a 10.2 μm diameter polystyrene particle in a standing wave field is approximately two orders of magnitude lower than the maximum primary acoustic radiation force given by (1). Neglecting this force in the present context is thus deemed reasonable.

For each simulation investigating particle behaviour, axisymmetric flow solutions were first acquired and then the steady state solution was used as the flow configuration in the separator. The particles were considered not to affect the fluid velocities as for their limited concentration and the trajectories of the particles were calculated leaving the flow unaltered. Integration of Newton's second law, with the forces mentioned above, for the particles was achieved using a predictor-corrector method.

Each operating case was tested with an overall separator diameter D=18 cm. Four virtual injection locations for the lipid particles were considered for each simulation, with radial positions at R=5.6 cm, R=6.6 cm, R=7.6 cm and R=8.6 cm for separator diameters of 12 cm, 14 cm, 16 cm and 18 cm respectively. This allowed the investigation of four separator diameters within a single simulation. The virtual injection points were chosen to be slightly further inwards than the physical edge of the separator to account for possible end effects in the ultrasonic field and manufacturing tolerances in the distribution feed system for the fluid. The acoustic radiation force was implemented in the model for 0.8 cm<r<8.6 cm. The lower limit was chosen to take into account end effects in the centre of the flow cell and the fact that no ultrasound is applied to the outlet pipe section. The injectors were distributed so as to have the lipid particles entering the separator at seven positions across the separator height. This condition served to represent a homogeneous mixture of lipid particles in blood entering the separator. A mass flow rate corresponding to a volume concentration of 0.5% was considered for each injector. Particles were injected three times in each simulation to represent the renewal of the suspension entering the separator. An image of the axisymmetric flow domain with the injection positions for the particles is shown in FIG. 3b.

The parameters investigated in the design study were volumetric flow rate of blood, separator height (or gap between the discs), separator diameter (within each simulation) and acoustic pressure amplitude. Flow rates of 4.17 cm³/s (250 cm³/min) and 1.04 cm³/s (62.5 cm³/min) were considered and gap sizes of 600 μm, 800 μm and 1 mm were investigated. Details of all the simulations are reported in Table 1.

TABLE 1
Parameters used in the simulations to investigate separation of
lipid particles from blood.

| Sim. | Q | H | | Injectors | | Pₒ |
|---|---|---|---|---|---|---|
| n. | (cm³/s) | (mm) | τ (s) | locations | τᵢₙⱼ (s) | (MPa) |
| L1 | 4.17 | 0.8 | 4.9 | R = 8.6 cm | 4.4 | 1 |
| | | | | R = 7.6 cm | 3.5 | |
| | | | | R = 6.6 cm | 2.6 | |
| | | | | R = 5.6 cm | 1.9 | |
| L2 | 1.04 | 0.8 | 19.5 | R = 8.6 cm | 17.8 | 1 |
| | | | | R = 7.6 cm | 13.9 | |
| | | | | R = 6.6 cm | 10.5 | |
| | | | | R = 5.6 cm | 7.5 | |
| L3 | 4.17 | 1 | 6.1 | R = 8.6 cm | 5.6 | 1 |
| | | | | R = 7.6 cm | 4.4 | |
| | | | | R = 6.6 cm | 3.3 | |
| | | | | R = 5.6 cm | 2.4 | |
| L4 | 1.04 | 1 | 24.4 | R = 8.6 cm | 22.3 | 1 |
| | | | | R = 7.6 cm | 17.4 | |
| | | | | R = 6.6 cm | 13.1 | |
| | | | | R = 5.6 cm | 9.4 | |
| L5 | 1.04 | 0.6 | 14.7 | R = 8.6 cm | 13.4 | 1 |
| | | | | R = 7.6 cm | 10.4 | |
| | | | | R = 6.6 cm | 7.9 | |
| | | | | R = 5.6 cm | 5.6 | |
| L6 | 1.04 | 1 | 24.4 | R = 8.6 cm | 22.3 | 0.707 |
| | | | | R = 7.6 cm | 17.4 | |
| | | | | R = 6.6 cm | 13.1 | |
| | | | | R = 5.6 cm | 9.4 | |
| L7 | 1.04 | 0.8 | 19.5 | R = 8.6 cm | 17.8 | 1 |
| | | | | (lipids) | | |
| | | | | R = 8.0 cm | 15.4 | |
| | | | | (platelets) | | |

Taking into account properties of blood and the hydraulic diameter as the length scale, Reynolds numbers for the flow at the injectors' locations vary between 0.65 and 4 when considering the different flow rates and gap heights. The Reynolds number is approximately equal to 28 and 7, when considering the higher and lower flow rate respectively, in both cases for r=0.8 cm. Simulation L7 was carried out considering only one injection location for the lipids, but adding one injection point for platelets. This had the aim of investigating the behaviour of the smallest blood components in the separator. The other parameters for this simulation were chosen as those for L2. The mass rate of platelets was chosen to be 1/20 of that of the lipids; this was so the properties of the fluid in the separator could be considered the same as for the other simulations. With this approach, this test looked at the fundamental behaviour of platelets in the separator without taking into account effects related to their concentration in blood.

Results and Discussion

Fluid Flow in the Separator

The solver produces solutions in terms of velocity components and pressure; a host of derivative quantities is subsequently available. Comparing the results for steady state and transient type simulations, the converged flow solutions for the transient cases showed negligible differences with the relevant final solutions for the steady state cases. For the grid independence study carried out, the results showed negligible differences (under 5% on the average) between the two solutions, proving that the flow configuration obtained was independent from the grid resolution considered.

Preliminary tests at a flow rate of 8.34 cm³/s were carried out, both with an axisymmetric configuration and in 3D, to determine a suitable diameter for the outlet pipe, Dₒᵤₜ; for these tests the gap between the discs was 800 μm. An inside diameter of 4 mm was found to give a relatively low Reynolds number in the outlet section, without causing the flow to go through too abrupt an expansion. The other diameter tested was 1 cm and gave a much lower average velocity in the pipe with formation of recirculation areas and stagnation zones which could affect the flow in the separator. The formation of stagnation zones would be even more likely at flow rates lower than 8.34 cm³/s.

A 3D simulation was carried out with a flow rate of 4.17 cm³/s at y=400 μm for a gap size H=800 μm and a separator diameter D=12 cm. The results are shown in FIG. 3c. It was observed that the flow accelerated towards the centre of the separator in an axially symmetric manner, reaching a peak in an annular region around the edge of the outlet. The radial velocity then falls again in the outlet. A similar trend was obtained for the 3D simulation with a flow rate 8.34 cm³/s. In both cases v_{θ} had negligible values in the separator part of the device, confirming the absence of azimuthal components. The radial velocity was also obtained from the axisymmetric simulation for Q=4.17 cm³/s, H=800 μm and D=18 cm. The results are shown in FIG. 3d. The radial velocity increased by more than one order of magnitude in the converging flow between the inlet and the centre of the separator. While an increase of the separator diameter provides a higher degree of acceleration to the fluid, it also provides a lower inlet fluid velocity and longer times spent by the particles in zones where the acoustic radiation force can compete with the fluid flow to divert the particles trajectories.

Particle Separation

The results of the simulations on particles behaviour were analyzed in terms of the relative mass and size distribution of lipid particles separated within the device. For each case, results were cast in terms of injector characteristic residence time, defined as

$${τ}_{inj} = \frac{{V}_{inj}}{Q} \qquad ( 8 )$$

where the volume considered for each injector is Vᵢₙⱼ=πR²H. The injector characteristic residence time gives an approximation of the average time spent by each fluid element in the radial flow part of the separator starting from the position R. This is only an approximation because different fluid elements have different velocities depending on their y and r positions. Considering that, in the absence of the acoustic radiation force, the relative velocity between the particle and the fluid would be negligible, the injector residence time provides an indication of the time that the particles are exposed to the acoustic radiation force. A flow profile with changing velocities gives rise to a distribution of residence times; some fluid elements will spend longer times in the separator than the characteristic residence time whereas others will have a shorter residence time than τᵢₙⱼ. Results were also considered for the overall residence time of the flow cell with diameter D=18 cm:

$$τ = \frac{{V}_{sep}}{Q} \qquad ( 9 )$$

where Vₛₑₚ=π(D²/4)H. This residence time represents the average time taken for a particle contained within a separator of diameter D=18 cm to travel from the inlet to the outlet and thus it represents a relatively high processing time for all injectors suitable for the evaluation of separator performance across different geometries over longer timescales than described by the injector residence time. Residence time data for all the simulations are reported in Table 1.

Effect of Flow Rate

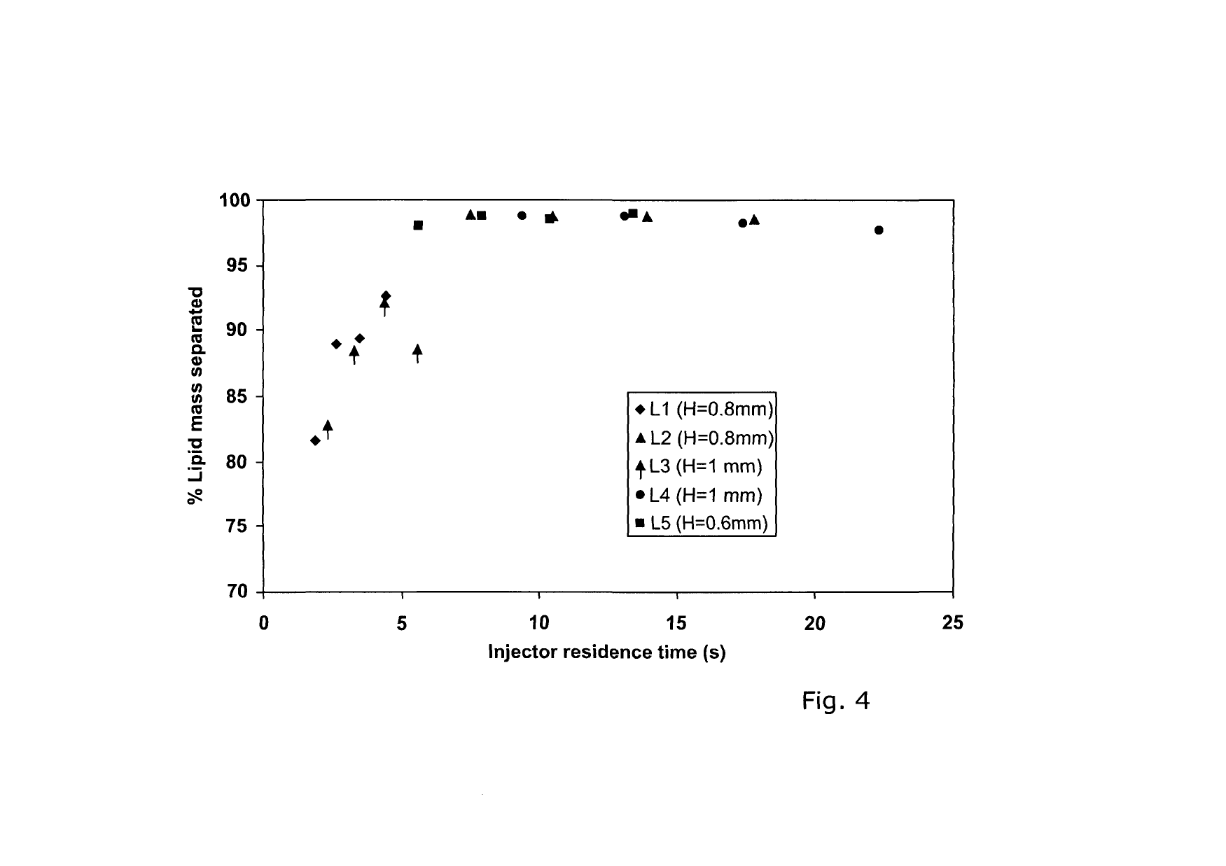

FIG. 4 shows particle separation performance versus injector residence time for simulations L1 to L5. The higher flow rate of simulations L1 and L3 corresponds to lower values of injector residence time, whilst the lower flow rate of simulations L2, L4 and L5 yields higher residence times. Below a critical value of residence time, the separation performance is found to increase with increasing residence time. Above this critical value (which in this case is around 5.6 s), the separation performance will be unaffected when considering relatively small changes in the gap size of the separator. Injector residence time is seen to provide a good predictor of separation performance, irrespective of the flow rate, gap size and separator radius used.

The separation performance results for simulations L1 to L6 are presented in terms of injector residence times in Table 2.

TABLE 2
Separation performance for simulations L1 to L6 in terms of
injector residence time.

| | % mass | | % mass | | % mass |
|---|---|---|---|---|---|
| τᵢₙⱼ (s) | separated | τᵢₙⱼ (s) | separated | τᵢₙⱼ (s) | separated |
| L1 | | L2 | | L3 | |
| 4.4 | 92.7 | 17.8 | 98.5 | 5.6 | 88.6 |
| 3.5 | 89.4 | 13.9 | 98.7 | 4.4 | 92.2 |
| 2.6 | 89.0 | 10.5 | 98.7 | 3.3 | 88.5 |
| 1.9 | 81.6 | 7.5 | 98.8 | 2.4 | 82.8 |
| L4 | | L5 | | L6 | |
| 22.3 | 97.7 | 13.4 | 99.0 | 22.3 | 97.8 |
| 17.4 | 98.2 | 10.4 | 98.5 | 17.4 | 97.8 |
| 13.1 | 98.7 | 7.9 | 98.7 | 13.1 | 92.2 |
| 9.4 | 98.7 | 5.6 | 98.0 | 9.4 | 92.2 |

Comparison of the results for L1 and L2, which correspond to flow rates of 4.17 cm³/s and 1.04 cm³/s respectively, shows that for the higher flow rate, the % of mass separated varies greatly with residence time, and that the injector which has the highest residence time (R=8.6 cm) gives the best performance. Table 3 reports the separation data in terms of separator residence time for simulations L1 to L6.

TABLE 3
Separation performance for simulations L1 to L6 in terms of
separator residence time.

| | L1 τ = 4.9 s | L2 τ = 19.5 s | L3 τ = 6.1 s |
|---|---|---|---|
| | % mass | % mass | % mass |
| R (cm) | separated | separated | separated |
| 8.6 | 92.3 | 97.5 | 87.6 |
| 7.6 | 81.1 | 96.3 | 80.6 |
| 6.6 | 71.5 | 95.0 | 60.4 |
| 5.6 | 59.6 | 93.5 | 47.8 |
| | L4 τ = 24.4 s | L5 τ = 14.7 s | L6 τ = 24.4 s |
| | % mass | % mass | % mass |
| R (cm) | separated | separated | separated |
| 8.6 | 97.2 | 98.5 | 97.0 |
| 7.6 | 95.5 | 96.5 | 95.5 |
| 6.6 | 94.0 | 94.5 | 75.0 |
| 5.6 | 93.0 | 93.0 | 63.8 |

These results again show a significant difference between the performance at 1.04 cm³/s (L2, L4, L5) and that at 4.17 cm³/s (L1 and L3). In particular, the two smaller separator diameters (12 cm and 14 cm) give considerably worse performance at the higher flow rate than at the lower one. Less than 85% separation would be obtained with a separator diameter of 16 cm (corresponding to R=7.6 cm) for gap sizes of 0.8 mm and 1 mm at 4.17 cm³/s. For this flow rate, larger diameters than those considered in this study would have to be taken into account to improve the separation performance.

Table 4 shows the separation performance achieved for each lipid particle size in simulations L1 and L3 (the data refer to the injector residence time).

TABLE 4
Separation performance for different lipid particle sizes used in
simulations L1 and L3 in terms of injector residence time.

| | | | | |
|---|---|---|---|---|
| τᵢₙⱼ (s) | 5 μm | 12.5 μm | 17.5 μm | 40 μm |

L1, % mass separated for each size

| | | | | |
|---|---|---|---|---|
| 4.4 | 91.7 | 90.0 | 100.0 | 100.0 |
| 3.5 | 91.7 | 85.0 | 100.0 | 100.0 |
| 2.6 | 87.5 | 85.0 | 100.0 | 100.0 |
| 1.9 | 80.0 | 80.0 | 77.5 | 100.0 |

L3, % mass separated for each size

| | | | | |
|---|---|---|---|---|
| 5.6 | 83.3 | 85.0 | 100.0 | 100.0 |
| 4.4 | 86.7 | 90.0 | 100.0 | 100.0 |
| 3.3 | 86.7 | 86.7 | 90.0 | 100.0 |
| 2.4 | 80.0 | 80.0 | 85.0 | 100.0 |

A general trend amongst all the data for 4.17 cm³/s is that the lipids not separated in the device span multiple sizes. For simulations L2, L4 and L5, which correspond to a flow rate of 1.04 cm³/s, it was only 5 μm particles that were not successfully separated: the relative amount of 5 μm particles not separated from the blood varied between 10% and 23%. It is thus shown that higher flow rates lead to worse separation performance as a wider range of particle sizes are not successfully removed. It should however be noted that higher removal ratios could be achieved by carrying out multiple passes through the separator.

Effect of Gap Size

Comparing simulations L1 and L3, changing H from 0.8 mm to 1 mm causes an increase in residence time, as the volume is higher for each injection location and a decrease in acoustic radiation force, as according to (1) this is inversely proportional to the ultrasound wavelength. At the same time, some of the particles, depending on their position, have to travel a longer distance to reach the collecting top plate of the separator.

The results shown in Table 3 show better performance for the simulations L1 and L2 with gap size 0.8 mm compared to L3 and L4 for a 1 mm gap size, even though the residence times are higher for the larger gap size. Comparing the results of the size distribution analysis for Q=4.17 cm³/s shows that, in the case of the smaller gap size (L1), 100% separation is achieved for all particles larger than 17.5 μm for all but the smallest injector residence time (1.9 s); by contrast, the larger gap size (L3) leads to less than 100% of 17.5 μm being separated for residence times below 4.4 s. These results show an effect of the acoustic radiation force, which is proportional to the particle volume and inversely proportional to the acoustic wavelength. The better the overall performance of the separator, the smaller will be the size of the particles separated. The particles most likely to be difficult to separate are those 5 μm particles injected very close to the bottom plate of the separator. Here the particles will have the largest distance to travel and at the same time they will experience the lowest acoustic radiation force as it can be seen from (1).

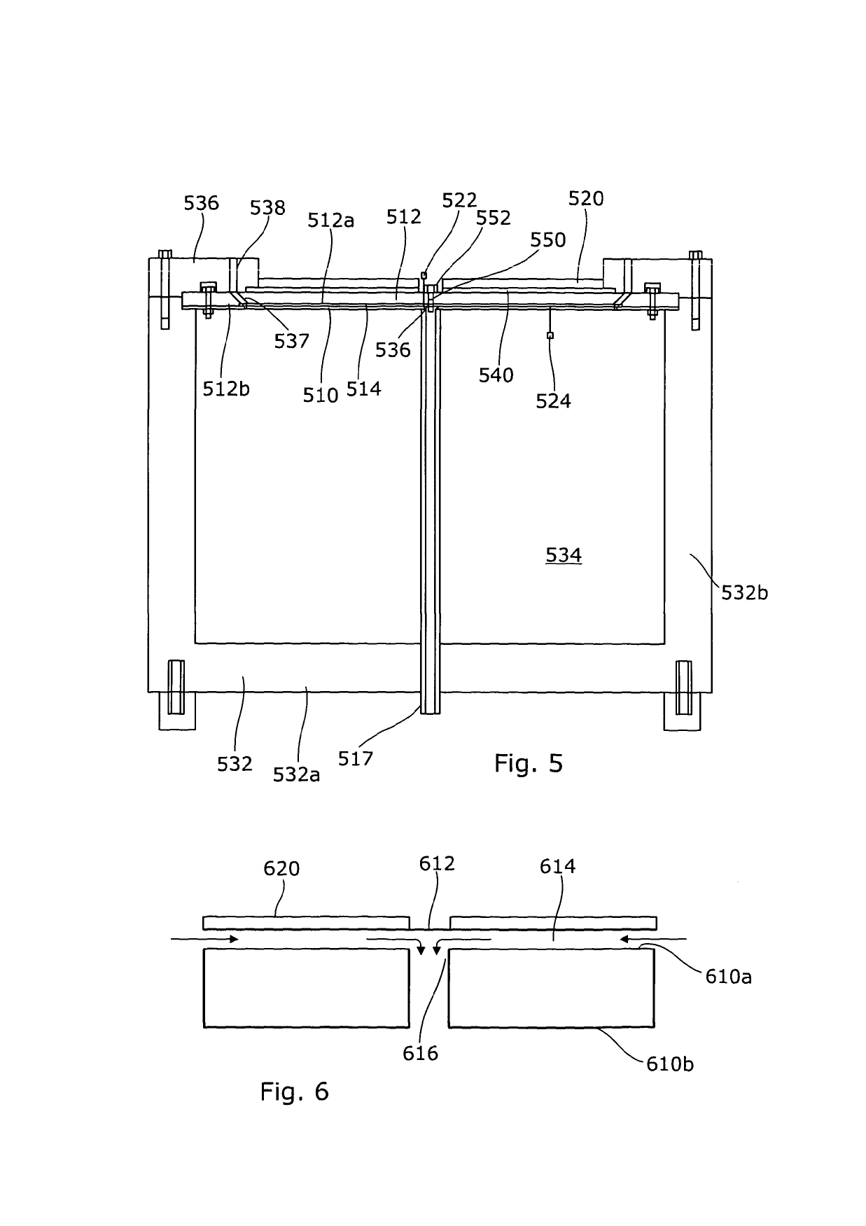

Comparing the separator performances achieved in simulations L2, L4 and L5 in Table 3, it can be observed that the 600 μm device provides a relatively high separation performance, but comparable to that obtained with 800 μm and 1 mm gaps. These results do not indicate a strong effect of gap size or separator diameter. In all cases a % of mass separated higher than 97% can be found for R=8.6 cm and a % of mass separated higher than 95% is observed for R=7.6 cm. These results show that using an acoustic pressure amplitude of 1 MPa, different separator gaps and diameters give a relatively high degree of separation of lipid particles from blood when operating at 1.04 cm³/s. As shown in FIG. 5, this once again suggests that injector residence times in the range 10.4 s-22.3 s will be close to optimal for maximum separation efficiency.

Effect of Acoustic Pressure Amplitude

Simulation L6 was carried out with the same parameters as L4 except for the acoustic pressure amplitude, which was 0.707 MPa instead of 1 MPa. As acoustic cavitation is more likely to occur at lower ultrasound frequencies and higher acoustic pressures, the use of lower acoustic pressures would make it possible to avoid or limit cavitation events that might affect the trajectories of the particles and have adverse effects on blood cell integrity. The lowest frequency considered in this case would be for the 1 mm gap size, which corresponds to an ultrasound frequency of 0.4 MHz when considering blood or water as the liquid in the separator. Values of acoustic pressure amplitude up to 1 MPa should give limited, or no, cavitation at this frequency; more information on this can only be obtained with experimental tests and this aspect will be investigated as part of the experimental characterization of the separator. Comparing the separation efficiency in Table 3 between L4 and L6 for different injector positions shows that the two larger separators, of 16 cm and 18 cm in diameter, would give comparable results in both cases, whilst the two smaller separators would perform significantly worse for L6. This shows that particular residence times have to be combined with an acoustic radiation force of appropriate magnitude in order to give significant degrees of separation.

Separation of Platelets

Simulation L7 was run over a particularly long time scale, in order to gain information on the behaviour of platelets which, by virtue of their small size, will experience a very small acoustic radiation force. After 30 seconds, 95.5% of the lipids have separated from the blood (this corresponds to the injector at R=8.6 cm for L2 at a longer time then considered in Table 3) and 60% of the mass of platelets have collected in the purified blood leaving the separator. The platelets left in the device appeared either to be separated on the lower surface of the flow cell or to be in areas of relatively low fluid velocity, in proximity of the walls of the separator. While some loss of platelets might be acceptable within the lipid separation operation, the acceptable ranges for platelet depletion in transfused blood are not yet available and need to be established clinically.

Clinical Relevance of the Results

The results obtained in this study show that separators with diameters of 16 cm or 18 cm and gap sizes of 600 μm, 800 μm or 1 mm give lipids separation performances of 95% or higher and of 97% or higher respectively (referring to the data of Table 3). This performance is equivalent or better than that found by Jönsson et al. who used USWs in an array of 8 microchannels and reported a range of lipid separation efficiencies between 66% and 94%. In the case of the radial flow separator the flow rate for which the best performance is obtained is 1.04 cm³/s which corresponds to 62.5 cm³/min. This flow rate would allow the processing of 625 cm³ of blood in 10 minutes; it is unlikely that the volume of PSB collected would be higher than this and 5 or 6 passes through the separator could be carried out in about 1 hour at the flow rate of 62.5 cm³/min. This value is more than 60 times higher than that reported by Jönsson et al. for the set-up with 8 microchannels. A lower number of passes than those indicated could be carried out on higher volumes of blood, still giving satisfactory degrees of separation of lipids over time scales of around 1 hour.

It will be appreciated that the modelling described above can be used, for any particular separator dimensions to model the effects of fluid flow rate on the separation efficiency, and to identify an optimum, or other target, flow rate. The fluid flow rate can then be controlled to maintain the target flow rate during operation of the separator. Alternatively, where a separator is to be used for a fluid having particular characteristics, and where a particular flow rate is needed, the modelling can be used to determine how the separation efficiency varies with separator dimensions, such as separation chamber axial thickness, outlet diameter, and radial distance of the inlet from the central axis. Once the optimum dimensions have been determined, the separator can be constructed so that it has those dimensions. In some embodiments, where the plate separation is adjustable, the separation chamber axial depth can be adjusted to an optimum value determined by the modelling. For example the upper and lower plates may both be rigid and adjustment screws may be provided to adjust the gap between them.

Referring to FIG. 5, in one embodiment of the invention the separation chamber 514 is formed between an upper plate 512 and a membrane 510 which forms the lower wall of the chamber 514. The upper plate 512 has a circular depression 512a in its under side with an annular rim 512b around it, and the membrane 510 secured against the annular rim 512b and held in tension across the depression 512a by a series of bolts 530. The separation chamber 514 is therefore defined in the depression 512 in the upper plate 512. The plate assembly comprising the upper plate 512 and membrane 510 is supported on a cylindrical support 532. The support 532 has a flat circular base 532a and a curved side wall 532b extending upwards from the base to define a gas chamber 534. The plate assembly 512, 510 is supported on the top of the side wall 532b so that it closes and seals the gas chamber 534, with the membrane 510 facing the gas chamber 534. The membrane 510 has a hole 536 in its centre, the edge of which is secured to the top of an outlet pipe 517 which extends vertically downwards from the membrane through the centre of the gas chamber 534 and out through a hole in the centre of the base 532a of the support 532.

An annular retaining ring 536 extends around, and over, the edge of the plate assembly 510, 512 and is bolted to the top of the support side wall 532b to retain the plate assembly 510, 512 in place. The upper plate 512 has a series of drillings 537 extending from its top surface down to the outer edge of the depression 512a, and the retaining ring 536 has a series of drillings 538 through it, each of which connects to one of the drillings 537 in the upper plate 512. These drillings 537, 538 therefore form a number of inlets which open into the radially outer edge of the separation chamber 514, at points evenly spaced around its circumference, through which fluid can be introduced into the separation chamber 514.

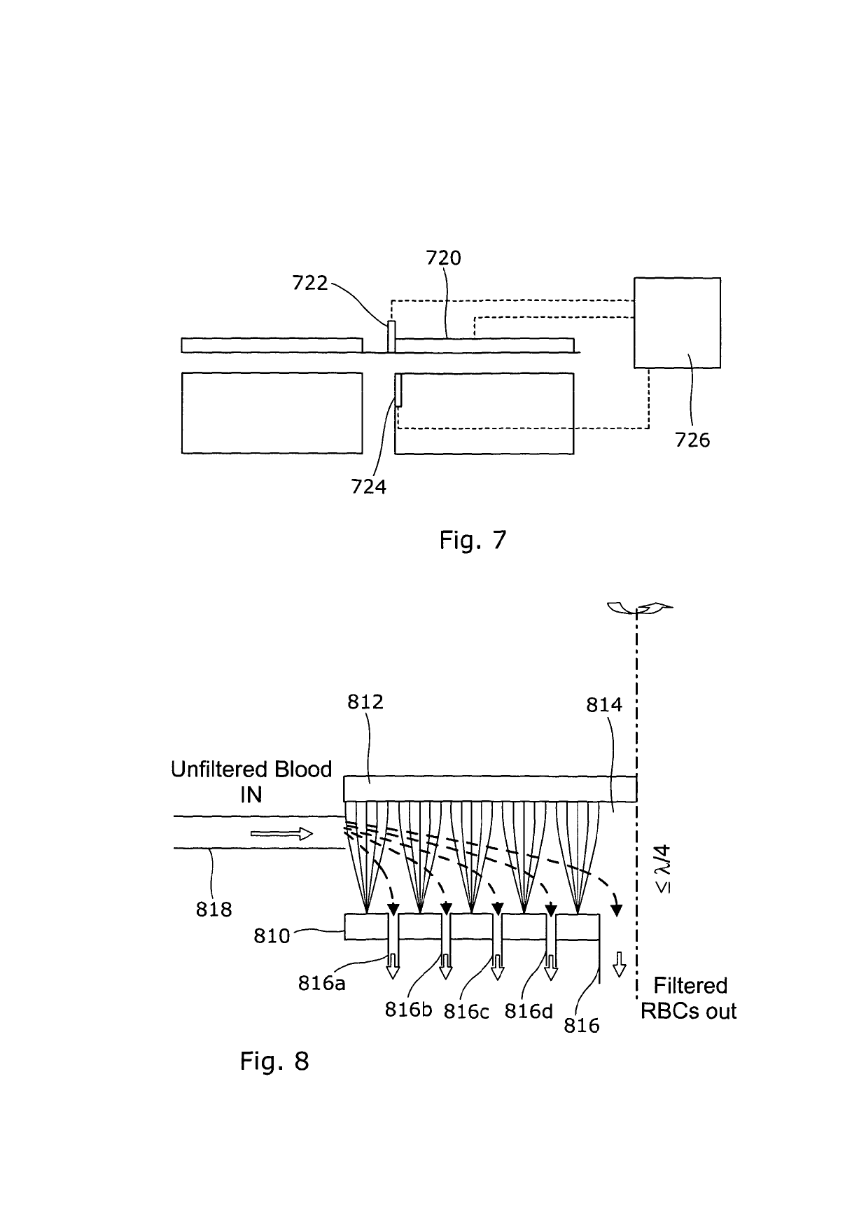

An annular transducer 520 is mounted on the outside of the upper plate 512, with a matching layer 540 between them to ensure transmission of the ultrasound from the transducer into the upper plate 512. A first pressure sensor 522 is mounted in the upper plate 512 and arranged to sense the pressure at the top of the separation chamber 514. A second pressure sensor 524 is mounted in the gas chamber 534 and arranged to sense the pressure at the bottom of the separation chamber 514. These can be connected to a control system as will be described in more detail below with reference to FIG. 7.

The upper plate 512 has a hole 550 through its centre, which can be closed with a screw 552 as shown. The hole 550 forms a secondary outlet, on the opposite side of the separation chamber 514 from the main outlet 516. This secondary outlet can be used as a venting port during priming of the separator. During operation, secondary outlet 550 can be used to remove particles which have accumulated in the centre of the separation chamber opposite the outlet 516. If the separator is used for short periods only, the separated particles, which may be lipids of the separator is used for separating lipids from blood, can be removed after each use of the separator, by removing the screw 552 and flushing out the separation chamber. Alternatively the screw 552 can be removed so that fluid, such as blood, can flow at very low flow rate, out through the secondary outlet 550, carrying the separated particles with it. If this flow rate is low enough it will not affect significantly the volume of flow through the main outlet 517. This flow can be allowed to occur under the pressure from the fluid in the separation chamber 514, or a suction device or pump can be provided to control the extraction of separated particles through the secondary outlet 550.

Another way in which the arrangement can be used is to unscrew the screw 552 part way so that the lower part of the hole 550 forms a closed cavity in centre of the upper wall of the separation chamber 514. As the particles collecting on the upper wall of the chamber tend to float in the fluid, they will tend to float upwards into the cavity out of the flow path of fluid towards the main outlet 516. This allows larger amounts of particles to be separated out of the fluid and accumulated before they will build up to the point where they start to be carried out of the main outlet 516 with the fluid. In a modification to this arrangement, the hole 550 and screw 552 can be replace by a fixed recess in the upper plate 512. In still further embodiments a number of recesses are provided in the upper wall of the separation chamber for the same purpose. However the advantage of a single recess at the centre of the separator is that it interferes least with the fluid flow through the separation chamber, and is located at the point where the separation is most complete.

In this embodiment, as indeed in the others described herein, rather than removing the accumulated particles by flushing them out, a removable lining or cartridge can be provided which lines the separation chamber, and which can be removed and disposed of after each use. This is particularly desirable in medical applications such as blood separation where all parts of the system that come into contact with the blood should be disposable. In some cases one wall of the lining can form the membrane.

Referring to FIG. 6, in a further embodiment of the invention a separator is the same as that of FIG. 1, including upper and lower plates 612, 610 defining a separation chamber 614, and a transducer 620. However, in this case the lower plate or reflector 610 is formed as an annular membrane 610a supported on a hollow annular drum 610b which extends around the outlet 616 of the separation chamber 614. The membrane 610a is supported at its radially inner and outer edges on the drum 610b so that it is held in tension, and the drum 610 contains gas, such as air, which may be at reduced pressure to form a partial vacuum, or any other material of substantially lower acoustic impedance than the fluid within the separation chamber. The membrane 610a can be formed of any suitable material such as latex or Mylar™ provided its thickness is significantly less than the wavelength of the ultrasound within it, so that it is ‘acoustically thin’ and therefore invisible to the acoustic wave. This allows the drum 610 to act as a substantially perfect reflector.

The arrangement of FIG. 6 results in the reflector 612 being effectively of a lower density, and a lower acoustic impedance, than the fluid in the separation chamber 616, which causes the reflected wave to be in anti-phase with the transmitted wave. This in turn tends to cause a pressure node at the reflector surface. This has the advantage that the standing quarter wave tends to be maintained even when the height of the chamber 616 is not exactly a quarter of the ultrasound wavelength. This makes the system resilient to changes in temperature and pressure which will cause the wavelength to vary. It will be appreciated that the membrane 510 and gas chamber 534 of the embodiment of FIG. 5 operate in a similar manner. In other embodiments a reflector of low acoustic impedance can be provided in other forms, such as a solid block of low impedance material.

Referring to FIG. 7, a further embodiment of the invention includes a control system that can also be used with each of the other embodiments described. Two pressure sensors 722, 724 are arranged to sense pressure at the top and bottom of the separation chamber 716 respectively. The outputs from these sensors are input to a controller 726 which is arranged to control the transducer to control frequency of the ultrasound it generates. The controller 726 is arranged to monitor the pressure amplitudes at the top and bottom of the separation chamber. As the amplitude of the pressure changes indicate how close the standing wave pattern is to the ideal quarter wave, and the controller 726 is arranged to vary the acoustic frequency until the desired standing wave pattern is achieved. In particular, in order to maintain a pressure node at the lower chamber wall, the controller may be arranged to vary the acoustic frequency so as to bring the measured changes in pressure towards a target value of, for example, amplitude. In this case the controller is arranged to minimize the changes in pressure detected by the lower pressure sensor 724. This is to maintain a pressure node at the lower chamber wall. In another embodiment the sensor 722 at the upper chamber wall can be omitted.

Referring to FIG. 8, a separator according to a further embodiment is again similar to that of FIG. 1 with corresponding parts indicated by the same reference numerals increased by 800. In this case, as well as the central outlet 816, a series of further outlets 816a, 816b, 816c, 816d are provided through the lower plate 810 at different distances from the rotational axis of the separator. The outlets 816, 816a, 816b, 816c, 816d are therefore also at different distances from the inlet 818 which is still at the radially outer edge of the separation chamber 814.

In this configuration, where the blood contains different types of particles, larger and/or denser particles will experience the greatest force upon entering the separation chamber 814, and will thus exit through the outlets that are closest to the outer edge of the circular separator, and therefore closest to the inlet 818. In this manner, bone fragments (which are 2-3 times as dense as RBCs) would be evacuated through the first few outlets 816a, 816b. White cells, which are as dense but considerably larger than red cells, would exit via the intermediate holes 818c, 816d. Red cells and platelets would then exit near the central opening. Obviously the number of outlets could be varied and could be selected so that a sufficient degree of separation is achieved.

A major difference with the blood-fat separator of FIG. 8 is that there will be loss of plasma volume, resulting in a more dense suspension of red blood cells at the central outlet 816. However this may be acceptable in some circumstances. In particular this design will be acceptable in other applications of the separator design, other than blood separation. The configuration of FIG. 8 has the advantage that it allows the separation of components that are all either denser or less dense than the suspending fluid.

It will be appreciated that, for all embodiments, while a quarter wave USW is ideal, the separator will operate with a standing wave pattern in the separation chamber which is less than a quarter wavelength. In theory any standing wave pattern of quarter wavelength or less will work in a similar way because, provided there are no nodes or anti-nodes within the chamber, the acoustic forces on the RBCs and lipid particles will be in opposite directions throughout the chamber. However the closer the standing wave comes to a full quarter wavelength, the greater the acoustic force will be. Also a standing wave with more than a quarter wavelength within the separation chamber will also work in some cases. If the standing wave is of slightly greater than a quarter wavelength then, since there will generally be an anti-node at the top produced by the transducer, the node will be above the bottom of the separation chamber. For example three eighths of a wavelength or less would be a suitable range of chamber heights in some cases. This means that, at the bottom of the chamber below the node, the acoustic forces will be in the opposite direction to those above the node. Therefore a small number of lipid particles will move towards the bottom of the separation chamber rather than the top. However, since the fluid flow rate close to the reflector will be much slower than that in the centre of the separation chamber, lipid particles collecting at the bottom of the chamber will not move quickly towards the outlet, and therefore, particularly if the separator is only used for short periods, this may not affect separation too significantly.

Also, while all of the embodiments described above have the form of a full annulus, in some cases it is sufficient for the separation chamber to comprise only a segment of an annulus, for example half, or a quarter of an annulus. In this case the separation chamber has side walls extending between the upper and lower plates. These will interfere slightly with the fluid flow between the inlet and outlet, but where the separation chamber is thin in the vertical direction this can still allow acceptable performance for some applications. Indeed other configurations in which the chamber is tapered inwards from the inlet to the outlet to provide converging fluid flow can also be used in some applications where it is not critical for all fluid flow paths between the inlet and outlet to be the same length. However, for these alternative embodiments it is preferable for the outlet to comprises an outlet duct which extends perpendicular to the side walls of the separation chamber, so that the fluid is turned through a right angle on leaving the separation chamber. This ensures that the fluid flow is similar to that of the embodiments described.

1. An acoustic separator comprising two parallel chamber walls defining a separation chamber therebetween, each chamber wall defining one side of the chamber, inlet means through which fluid can flow into the chamber, and outlet means through which fluid can flow out of the chamber, wherein one of the chamber walls includes a transducer arranged to transmit pressure waves across the chamber towards the other of the chamber walls which in turn is arranged to reflect the pressure waves to set up a standing wave in the chamber, and the outlet means defines an opening in one of the sides of the chamber.

2. A separator according to claim 1 wherein the chamber is at least part annular so that fluid flow through the chamber is substantially radial.

3. A separator according to claim 2 wherein the chamber is annular.

4. A separator according to claim 2 wherein the inlet means is radially outward of the outlet means.

5. A separator according to claim 2 wherein the inlet means is at the radially outer edge of the chamber.

6. A separator according to claim 2 wherein the outlet means is at the radially inner edge of the chamber.

7. A separator according to claim 1 wherein the outlet means is one of a plurality of outlet means which are located at different distances from the inlet means.

8. A separator according to claim 1 wherein the standing wave within the chamber is less than one wavelength in length.

9. A separator according to claim 8 wherein the standing wave has an anti-node at said one of the chamber walls and a node which is further from said one of the chamber walls than from the other of the chamber walls.

10. A separator according to claim 7 wherein the standing wave within the chamber is at most a quarter wavelength.

11. A separator according to claim 10 wherein the standing wave within the chamber is about a quarter wavelength.

12. A separator according to claim 1 wherein said other of the chamber walls has an acoustic impedance which is lower than that of the fluid.

13. An acoustic separator comprising two parallel chamber walls defining a separation chamber therebetween, inlet means through which fluid can flow into the chamber, and outlet means through which fluid can flow out of the chamber, wherein one of the chamber walls includes a transducer arranged to transmit pressure waves across the chamber towards the other of the chamber walls, which has a lower acoustic impedance than the fluid and is arranged to reflect the pressure waves to set up a standing wave in the chamber.

14. An acoustic separator according to claim 12 wherein said other of the chamber walls comprises a membrane.

15. A separator according to claim 14 wherein the membrane is supported in tension.

16. A separator according to claim 14 wherein the membrane is supported between the chamber and a gas.

17. A separator according to claim 14 wherein said other of the chamber walls further comprises support means arranged to support the membrane and to contain a volume of gas on the opposite side of the membrane to the chamber.

18. A separator according to claim 13 further comprising a pressure sensing means arranged to measure variations in pressure produced by the transducer and control means arranged to control the frequency of the pressure waves in response to an output from the pressure sensing means.

19. A separator according to claim 18 wherein the pressure sensing means is arrange to measure pressure at said other of the chamber walls.

20. A separator according to claim 18 wherein the control means is arranged to vary the frequency so as to bring the variations in pressure towards a target variation.

21. A separator according to claim 20 wherein the target variation is zero variation.

22. A separator according to claim 13 wherein a recess is defined in the other of the sides of the separation chamber to collect particles separated out of the fluid.

23. A separator according to claim 13 wherein a secondary outlet is defined in the other of the sides of the separation chamber through which particles separated out of the fluid can be removed from the separation chamber.

24. A separator according to claim 23 further comprising a removable lining for the separation chamber.

25. A separator according to claim 13 wherein the chamber walls are orientated so as to be substantially horizontal, and the transducer is arranged to transmit the pressure waves in a vertical direction.

26. A separator according to claim 25 wherein the transducer is arranged to generate the standing wave with an anti-node at the top of the separation chamber.

27. A method of separating particles from a fluid comprising providing a separator operating the transducer to generate the standing wave, and passing the fluid through the separation chamber.

28. A method according to claim 27 comprising modelling fluid flow in the separator to determine a target value for a parameter of the separator, and controlling the parameter to maintain it at the target value.

29. A method according to claim 28 wherein the parameter is controlled by constructing the separator so that the parameter has the target value.

30. A method of constructing a separator according to claim 1 for separating particles from a fluid, the method comprising modelling fluid flow in the separator to determine a target value for at least one parameter of the separator, and constructing the separator so that the parameter has the target value.

31. A method according to claim 28 wherein the parameter is flow rate of the fluid through the separator.

32. A method according to claim 28 wherein the parameter is a dimension of the separation chamber.

33. A method according to claim 28 wherein the parameter is controlled by adjustment of the separator.
